(19) United States
(12) Patent Application Publication
(10) Pub. No.: US 2010/0032086 A1
(43) Pub. Date: Feb. 11, 2010

(54) Decoration Method of Ceramics

(75) Inventor: GwangBok Hwang, Jeollabuk-do (KR)

Correspondence Address: BACON & THOMAS, PLLC, 625 SLATERS LANE, FOURTH FLOOR, ALEXANDRIA, VA, 22314-1176, US

(73) Assignee: RichStone Ltd, Jeonbuk (KR)

(21) Appl. No.: 12/086,078

(22) PCT Filed: Dec. 9, 2005
(86) PCT No.: PCT/KR2005/004218

§ 371 Date: Sep. 15, 2009

(51) Int. Cl. B32B 38/04

(52) U.S. Cl. 156/268

(57) ABSTRACT

Decoration method of ceramics is provided that can form easily the intended various color patterns, is excellent in pattern repeatability, and is suitable to the mass production at low cost, by laying at least one coloring material layer or more on the surface of a molded ceramic body and by cutting a portion of the coloring material layer so that the color pattern on an exposed surface is expressed.

### TECHNICAL FIELD

The present invention relates to a decoration method of ceramics.

### BACKGROUND ART

Traditional methods of decorating the surface of a ceramic body include a method of making a rough sketch on its body and glazing thereon before high-temperature firing, a method of using colored basic or unglazed clay, etc. As examples of the method using such a colored basic clay, there are a milefiore technique which involves blunging basic clay with natural colors or multicolor clay containing metallic oxides and combining them together to create patterns and/or a marbling technique, that is, a neriage technique which uses different colored basic clay pieces pressed together in an engraved frame to create the same pattern both inside and outside of the ceramic body. In order to get a desired pattern, however, a process of drawing underglaze or kneading clay has to be done manually. Especially, in case of forming a stereoscopic pattern or spot pattern, it needs to glaze the surface of a ceramic repeatedly or color separately, which increases the cost of manufacture.

One of methods for decorating pottery with rugged surface texture or spot pattern is disclosed in Japanese Patent Laid-Open Publication No. H 03.262684 in which a flit made of particles and/or particulate glaze and slurry glaze are mixed and glazed over the surface of the porcelain. Even though this method helps to express a spot pattern with easiness, it is difficult to express other diverse patterns and reproducibility of the pattern is questionable.

Japanese Patent Laid-Open Publication No. 2000-7468 describes another method in which a transfer paper for decoration is applied to a glazed surface of a pottery having been baked twice or fired twice and then subjected to the high-temperature firing at a temperature of about 1,000 to 1,200° C. or over, to thereby form a protruded transfer layer on the glazed surface. Although this method may be efficient for decorating the flat surface with patterns having ruggedness sensation, it still has several problems that high-temperature firing is required once again after the transfer paper was applied, it requires the use of an expensive screen printer, and the overall decorating process is complicated.

According to another method disclosed in Japanese Patent Laid-Open Publication No. H 06.262615, which expresses a three-dimensional pattern on the surface of a ceramic body, after a molded ceramic body is dried, the surface of the ware is coated with a liquid to be adsorbed onto the ware to make a pattern. Before it is dried, the surface of the ware is blasted and only a dried surface portion not being coated with the liquid is peeled off so as to express a three-dimensional pattern by leaving the portions coated with the liquid on the surface of the ceramic body. However, one problem with the method is that although the portions coated with the liquid can be colored, an additional process is required to form a colored layer on the blasted portion because it is the original of the ceramic body. For the reason, the method gets complex and inconvenient for expression of multicolor patterns.

### DISCLOSURE OF INVENTION

### Technical Problem

Therefore it is an object of the invention to provide a decoration method of ceramics which can express the intended various color patterns easily, which can form a pattern with excellent repeatability, and which is suited for a mass production at low cost.

### Technical Solution

In view of above purpose as a result of the devoted research, the inventor found and reached the present invention that the intended various color patterns can be formed to ceramics easily with excellent repeatability at low cost when one lays at least one coloring material layer on the surface of the molded ceramic body, cuts a portion of the coloring material layer, and thereby lets the color patterns to be expressed on the exposed surface.

In other words, the decoration method of ceramics of the present invention is characterized in that at least one coloring material layer is laid on the surface of a ceramic body, a portion of the coloring material layer is cut and thereby the color pattern is expressed on the exposed surface. It is preferred that the coloring material layer is composed of more than one layer of each different hue. A taper shaped cutting site is preferred to be formed at the coloring material layer on the smooth area of the ceramic body.

It is preferred that the ceramic body has a convex portion on its surface. In a convex portion of the ceramic body, it is preferred that the coloring material layer is laid, at least, on convex superior portion and around its neighborhood, the coloring material layer of the convex portion and around its neighborhood is cut through the depth where the convex portion or the intended color pattern is exposed, and the color pattern is formed by the coloring material layer expressed on the exposed surface of the convex portion and around it.

It is preferred that the ceramic body has a concave portion on its surface. In a concave portion of the ceramic body, it is preferred that the coloring material layer is laid, at least, on concave superior portion and around its neighborhood, the coloring material layer of the concave portion and around its neighborhood is cut through the depth reaching the ceramic body around the concave portion, and the color pattern is formed by the coloring material layer exposed in the concave portion.

### ADVANTAGEOUS EFFECTS

According to this invention, intended various color patterns can be formed to the ceramics easily with excellent repeatability at low cost. According to this invention, it is also easy to give a three-dimensional appearance to the color pattern. This makes it possible for this invention to be suited for a mass production of decorating ceramics. The decoration method of the invention is applicable to the decoration of various kinds of ceramics such as tableware, flowerpot, brick, sidewalk block, tile, decorative article, outdoor/indoor tile, bathtub, toilet, and terra-cotta.

### BRIEF DESCRIPTION OF THE DRAWINGS

The above and other objects and features of the present invention will become apparent from the following description of the preferred embodiments given in conjunction with the accompanying drawings, in which:

FIG. 1 is a schematic view illustrating an embodiment of a device to cut a ceramic body;

FIG. 2 is a plan view of the device depicted in FIG. 1;

FIG. 3 is a schematic view of another embodiment of a device for cutting a ceramic body;

FIG. 4(a). is a partially enlarged sectional view showing an example of a ceramic body on which a coloring material layer is laid, FIG. 4(b) is a partially enlarged sectional view showing the state that the coloring material layer of FIG. 4(a) is cut, and FIG. 4(c) is partially enlarged plan view showing the state that the coloring material layer of FIG. 4(a) is cut;

FIG. 5(a) is a partially enlarged sectional view showing another example of a ceramic body on which a coloring material layer is laid, FIG. 5(b) is a partially enlarged sectional view showing the state that the coloring material layer of FIG. 5(a) is cut, and FIG. 5(c) is partially enlarged plan view showing the state that the coloring material layer of FIG. 5(a) is cut;

FIG. 6(a) is a partially enlarged sectional view showing again another example of a ceramic body on which a coloring material layer is laid, FIG. 6(b) is a partially enlarged sectional view showing the state that the coloring material layer of FIG. 6(a) is cut, and FIG. 6(c) is partially enlarged plan view showing the state that the coloring material layer of FIG. 6(a) is cut;

FIG. 7(a) is a partially enlarged sectional view showing again another example of a ceramic body on which a coloring material layer is laid, FIG. 7(b) is a partially enlarged sectional view showing the state that the coloring material layer of FIG. 7(a) is cut, and FIG. 7(c) is partially enlarged plan view showing the state that the coloring material layer of FIG. 7(a) is cut;

FIG. 8(a) is a partially enlarged sectional view showing again another example of a ceramic body on which a coloring material layer is laid, FIG. 8(b) is a partially enlarged sectional view showing the state that the coloring material layer of FIG. 8(a) is cut, and FIG. 8(c) is partially enlarged plan view showing the state that the coloring material layer of FIG. 8(a) is cut;

FIG. 9(a) is a partially enlarged sectional view showing again another example of a ceramic body on which a coloring material layer is laid, FIG. 9(b) is a partially enlarged sectional view showing the state that the coloring material layer of FIG. 9(a) is cut, and FIG. 9(c) is partially enlarged plan view showing the state that the coloring material layer of FIG. 9(a) is cut;

FIG. 10(a) is a partially enlarged sectional view showing again another example of a ceramic body on which a coloring material layer is laid, FIG. 10(b) is a partially enlarged sectional view showing the state that the coloring material layer of FIG. 10(a) is cut, and FIG. 10(c) is partially enlarged plan view showing the state that the coloring material layer of FIG. 10(a) is cut;

FIG. 11(a) is a partially enlarged sectional view showing again another example of a ceramic body on which a coloring material layer is laid, FIG. 11(b) is a partially enlarged sectional view showing the state that the coloring material layer of FIG. 11(a) is cut, and FIG. 11(c) is partially enlarged plan view showing the state that the coloring material layer of FIG. 11(a) is cut;

### MODE FOR THE INVENTION

Hereinafter, preferred embodiments of the present invention will be set forth in detail with reference to the accompanying drawings.

A decoration method of ceramics in the present invention includes (1) a process of molding a ceramic body; (2) a process of forming a coloring material layer; (3) a process of cutting the coloring material layer; (4) a process of glazing the ceramic body; and (5) a process of firing the glazed ceramic body. Details of each process will be given below.

Process of Molding

Materials to mold a ceramic body have no particular restriction and include basic clays of all sorts of genre such as basic clays composing well-known earthenware, pottery, stoneware, and porcelain. Feldspart and/or pumice stone and/or quartz and/or pigment may be added to the above materials. The shapes of ceramic body have no particular restriction, and include, for example, tableware, flowerpot, brick, decorative article, outdoor/indoor tile, bathtub, toilet, and terra-cotta.

Molding methods of a ceramic body depending on the intended shape, include, but are not limited to, well-known methods such as molding of pouring muddy water in a plaster mold (i.e. plaster mold casting), pressure casting molding, mechanical turning wheel molding, roller machine molding, press molding, and extrusion molding. Preferred methods of molding for relatively complicated ceramic ware such as table ware are plaster molding casting, pressure casting molding, mechanical turning wheel molding, and roller machine molding that each method uses plaster molding. In such a case, not just a plaster molding but a die may be used as needed.

In case of forming a concavity and convexity on the ceramic surface for the decoration, it is preferred that convexo-concave carved pattern attached on the plaster molding is stamped on a wet ceramic body. If needed, cutting or, formation of concavity and convexity by stamping (a pattern formed by imprinting an object on which hard pattern is engraved like a seal on the ceramic body before it is dried) may be applied on the surface of the demolded ceramic body. The concavity and convexity may be formed after the first coloring material layer or the second coloring material layer is laid on using the above method. The concavity and convexity may be formed before and after the first, the second, the third coloring material layer is laid on if needed.

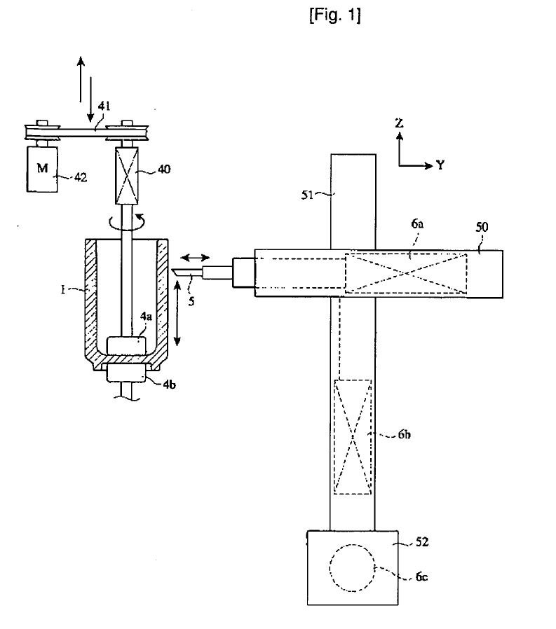

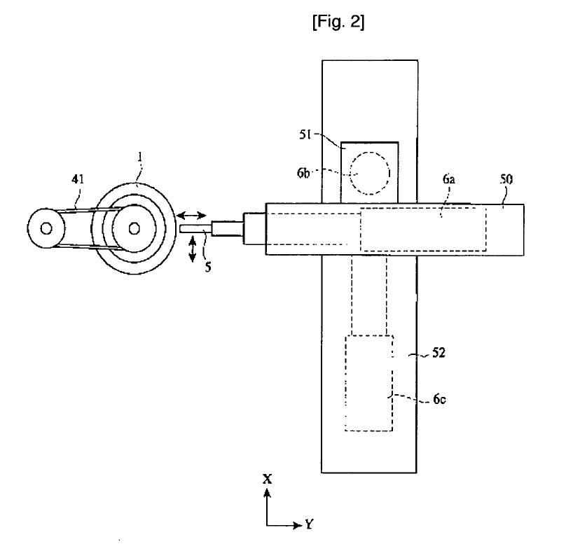

A method on how to form a concavity and convexity by cutting the surface of the ceramic body will be described with referent to the drawings. FIG. 1 is a schematic view showing an example of a device to cut the ceramic body shaped like a vessel. FIG. 2 is a schematic plan view of the device shown in FIG. 1. The device has grip 4a and 4b holding the bottom of the ceramic body from the both side, and a cutting means 5 to cut the lateral side of the ceramic body 1. The grip 4a is rotatably supported by cylinder 40 and is rotary driven by the belt power train 41-mediated motor 42. The grip 4b may be rotary driven by the motor 42 together with grip 4a or may be rotatably supported only by cylinder and the like. As a means to hold the ceramic body 1, it is not limited to use grip 4a and 4b but it may use, for example, a rotating chuck holding each top and bottom of the ceramic body 1.

The cutting means 5 is mounted on a translatory actuator 6a housed in outer case 50 which is located in the direction of the second axis (y axis) perpendicular to the direction of the first axis (z axis) parallel to the central axis of the ceramic body 1, and is movable to the direction of y-axis in conjunction with the translatory actuator 6a.

The outer case 50 is mounted on the translatory actuator 6b housed in the outer case 50 which is located in the direction of z-axis, and is movable to the direction of z-axis in conjunction with the translatory actuator 6b. The outer case 51 is mounted on the translatory actuator 6c housed in the outer case 52 which is located in the direction of the third axis (x-axis) perpendicular to the direction of the z- and the y-axis, and is movable to the direction of x-axis in conjunction with the translatory actuator 6c. Therefore the cutting means 5 is movable three-dimensionally.

The cutting means 5 include blades, routers, grinders, roll grinders, etc. The cutting means 5 can be attached on the translatory actuator, and can be provided with flexibility such as forward and backward movement of the z-, y- and x-axis to cut along the irregular curved surface of the ceramic body (e.g. of egg shape or oval shape). The translatory actuator 6a, 6b, and 6c include hydraulic cylinders, air cylinders, etc. In either case of using hydraulic cylinder or air cylinder, it can be driven by a motor.

The translatory drive mechanism of each x-, y-, and z-direction are not restricted to the mechanism of employing the translatory actuator 6a, 6b, and 6c, and could include other mechanism, for example, composed of racks and gears. The cutting means 5 can be also driven by a robot arm instead of a mechanism employing the translatory actuator 6a, 6b, and 6c.

It is preferred that motors driving the translatory actuator 6a, 6b, and 6c, and the motor 42 rotary driving the grip 4a are controlled by electronic control device which processes the signal according to the pre-memorized program. In case of employing the robot arms, it is preferred that they are controlled by electronic control device which processes signal according to the pre-memorized program. Since the position and cutting depth of the cutting means 5 to the ceramic body 1 can be controlled freely by employing the devices described above, the intended convexo-concave shape can be formed with high accuracy at short times.

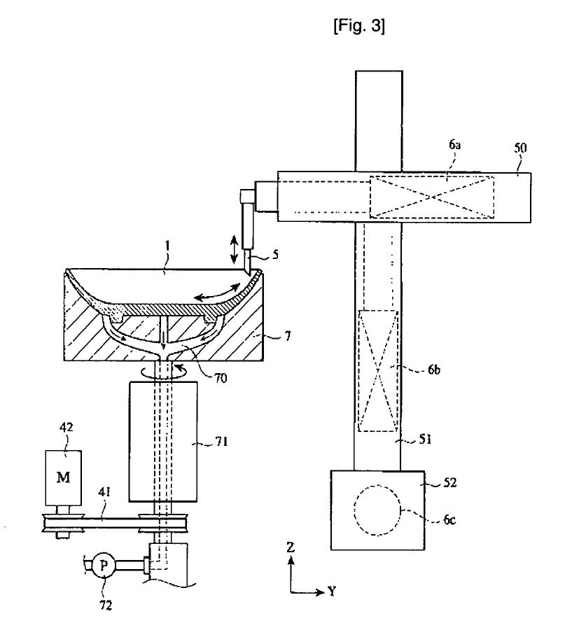

FIG. 3 illustrates an example of a device to cut the ceramic body of a dish shape. In FIG. 3 puts the same reference numbers for the same components and parts shown in the FIG. 1. In this example, a pedestal 7 having a vacuum hole 70 is employed as a means to hold the ceramic body 1. The pedestal 7 is rotatably supported by a spindle unit 71 and is rotary driven by a belt power train 41-mediated motor 42. The ceramic body 1 is placed so as its back side to be directly contacted with the pedestal 7 and is fixed on the pedestal 7 by the actuation of a vacuum pump 72. It is preferred that the pedestal 7 is made of silicon rubber, etc. The types of the cutting means 5, the three dimensional locomotion controls of the cutting means 5, and the control of the motor 42 may be the same as above. In case of cutting the back side of the dish shaped ceramic body 1, it can use the pedestal 7 whose shape is along the top surface of dish shaped ceramic body 1.

Process of Forming the Coloring Material Layer, and Process of Cutting

The processes of forming a coloring material layer and of cutting the coloring material layer are described as below with reference to the accompanying drawings.

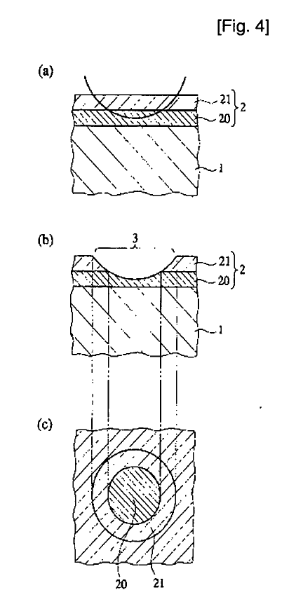

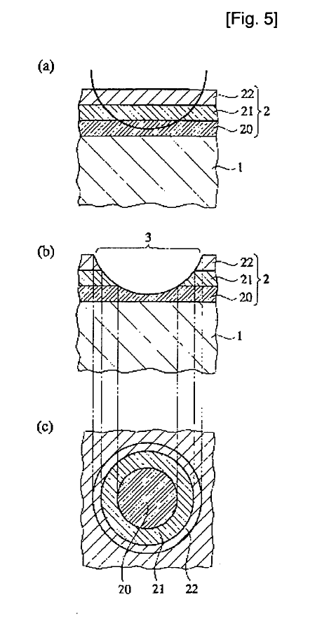

FIGS. 4 and 5 illustrate examples of forming a coloring material layer on a smooth surface of the ceramic body and of cutting a portion of the coloring material layer. In the examples shown FIG. 4, the coloring material layer 2 composed of the first layer 20 and the second layer 21 of each different hue is laid on the surface of the ceramic body 1. As a coloring material 2, there are underglaze colors (underglaze color is used for drawing on the surface of a ceramic body as a usual decoration method. White porcelain of Choseon Dynasty in Korea is made by drawing with blue, brown, or red underglaze color on the surface of the ceramic body, by glazing it with a transparent oil, and by firing it), clays, glazes, color engobes, etc., but the color engobe is preferable because it can express the intended hue easily and is unaffected by the coloring material layer 1 especially when the hue of the green body such as celadon clay or Sancheong clay is dark. (Sancheong clay is clay mined in Sancheong province in Korea which is rich in iron and whose grain is a little coarser than white porcelain clay or celadon clay).

As a coating means of the color engobe, there are air brushing, immersion, spin coating, and brushing, but air brushing is preferred. Air brushing makes it possible to coat the color engobe effectively and to control the thickness of the layer easily. For example in case of coating all of the lateral face or top face of the ceramic body, one can coat the color engobe on the ceramics uniformly by air brush rotating the ceramics by a driving means such as a motor after placing the ceramics on the rotatable pedestal.

As an air brush, although movable one is not required but is preferred. To make the air brush movable, same mechanism as the three dimensional locomotion control mechanism of above cutting means can be used, and it is preferred that the motor which controls the movement of the air brush and the motor which rotates the ceramics are controlled by a electronic controller which processes the signal memorized in the program.

In case the clay or the color engobe is applied as the coloring material 2, the clay or the color engobe can be coated on the surface of the ceramics by air brush, immersion, spin coating, brushing, etc. depending on the shape of the ceramics after it is diluted with a solvent such as water to a paste state, but is coated most preferably by air brushing. The coloring material layer 2 is not necessarily to be applied on the entire surface of the ceramic, can be applied on the limited area intended to form a pattern, and is preferable to use air brushing, in such a case, after masking around the limited area. The coloring material layer 2 can be applied by at least only layer, and can be applied by several layers depending on the color pattern of the intended area.

The thicknesses of the first layer 20 and the second layer 21 respectively composing the coloring material layer 2 are usually in a range of 0.01 to 3 mm (hereinafter same), though are determined depending on the intended color pattern. The hue or color of each coloring material layer 20 and 21 can be laid on suitably depending on the color pattern of the intended area.

The ceramic on which the coloring material 2 is applied, is dried until the coloring material 2 is ready to cut. It is preferred that the drying is carried out under the environment that a constant temperature and a constant humidity are maintained. In case the strength of a ceramic body 1 is not high enough to tolerate the cutting at the subsequent stage, the ceramic on which coloring material layer 2 is applied may be baked temporarily or may be biscuit fired. In either case, it is preferred that the ceramic coated with the coloring material layer 2 is put into a kiln, and is heated to a temperature of about 500 to 1,000° C. The entire ceramic body is not necessarily required to be baked, and only the area contacting the holding means during the cutting can be baked temporarily. The partial and temporal baking methods include a method of heating the ceramic body 1 in an electric oven which can control the temperature distribution, a method of blowing partial hot air until the ceramic body 1 is not deformed, etc.

In the example of FIG. 4, the color pattern of round shape by the first layer 20 at an exposed surface 3 as shown in FIG. 4.(b) and (c) is formed by drying the coloring material layer 2 shown in FIG. 4.(a), and by cutting it as an earthenware shape (which is a small bowl of porcelain used in grinding a medicine) to the depth reaching the first layer 20.

All of the means (means to hold ceramic, means to cut, means to move the cutting means three-dimensionally, and means to rotate ceramic) and their controls used during the cutting of the coloring material layer 2 can be same as the case of forming the concavity and convexity by cutting the ceramic body as above described, and therefore the description about them are omitted. However, in case of forming a cutting area of earthenware shape shown in FIG. 4, a router is preferred as the cutting means. In case of forming the cutting area of earthenware shape, a sand blast method can be employed after the masking so that only the portion to be cut can be exposed.

FIG. 5 illustrates an example of forming a coloring material layer 2 consisted of three layers, the first layer 20, the second layer 21 and the third layer 22, and of cutting the portion of it. In case three coloring material layers, 20, 21 and 22 are laid on, one can form the color pattern of two-layered round shape composed of the first layer 20 and the second layer 21 on the exposed surface 3 as shown in FIGS. 5(b) and (c) by cutting as an earthenware shape into the depth reaching the first layer 20.

Moreover, in case of forming the coloring material layer 2 consisted of three layers as shown in FIG. 5, various color patterns can be formed by setting a cutting area reaching the depth of the second layer 21 and by setting a cutting area reaching the depth of the first layer 20.

In case of cutting the coloring material layer 2 laid on the smooth surface of the ceramic body as shown in FIGS. 4 and 5, it is preferred that a tapered surface is formed in order to express a color pattern, and the color pattern expressed on the exposed surface 3 can be changed variously by changing suitably the shape of cutting area or the angle of cutting to the coloring material layer 2. One can also cut to the depth reaching the ceramic body, and thereby one can form colors which include the hue of the ceramic body. The shape of cutting area is not limited as long as it has the tapered surface, and includes besides earthenware shape, geometrical shapes such as conical shape, pyramid shape and semiglobular shape, and grooves after the model of characters, irregular shape, and specific objects (such as flowers, animals, wood grains).

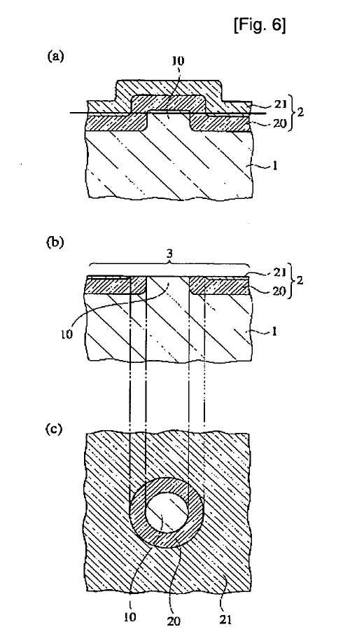

FIGS. 6 to 8 illustrate examples that the coloring material layers are laid on the surface where the columnar convex portion is formed, and are cut. In the example of FIG. 6, the first layer 20 which is thinner than the height of convex portion 10 is laid on, and the second layer 21 is laid on the first layer 20. As shown in FIGS. 6(b) and (c), the color pattern of double circle on the exposed surface 3 composed of exposed surface of convexed area 10 and the first layer 20 can be formed by cutting uniformly the convexed area 10 and its neighborhood to the depth reaching the upper end of convexed area 10 along the faces of a ceramic. As cutting means to cut uniformly along the face of the ceramic, a blade or a roll grinder is preferred, but a sand blast method can be also used as needed.

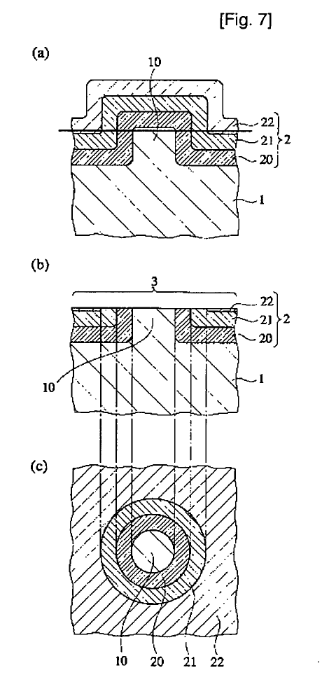

In the example of FIG. 7, the first layer 20 and the second layer 21 are laid on so that their total thicknesses are less than the height of the convex 10, and the third layer 22 is laid on them. As shown in FIGS. 7(b) and 7(c), the color pattern of tripled circle on the exposed surface 3 composed of exposed surface of the convexed area 10, the first layer 20, and the second layer 21 can be formed by cutting uniformly the convexed area 10 and its neighborhood to the depth reaching the upper end of the convexed area 10 along the face of the ceramic body.

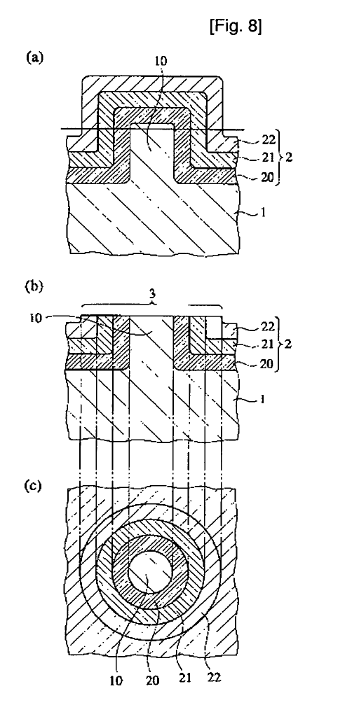

In the example of FIG. 8, the coloring material layers 20, 21, and 22 are laid on so that their total thicknesses are less than the height of a convexed area 10. As shown in FIG. 8, by cutting the convexed acrea 10 and its neighborhood uniformly to the depth reaching to the upper end of the convexed area 10 along the face of a ceramic body, the color pattern of tripled circle composed of the exposed area of convex 10, the first layer 20 and the second layer 21 can be formed and can be embossed than its surroundings so that it produces a three-dimensional effect.

Although the ceramic having the three layers of the coloring material layer 20, 21, and 22 has a number of convexes 10, not necessarily for all convexes 10 are needed to be cut to the depth reaching the upper end of convex 10, and the cutting area can be set to the depth reaching the first layer 20 or the second layer 21 so that it can form various color patterns.

As described above, when a convexed area is prepared on the ceramic body in advance, a color pattern can be formed by only cutting uniformly the convex 10 and its neighborhood to the predetermined depth along the face of the ceramic body after the coating of the coloring material layer 2. The color patterns to be exposed can be changed diversely by changing suitably the shape of the convex 10 and the cutting angle to the coloring material layer 2. The shape of the convexed area 10 has no particular restriction and includes, besides columnar shape, geometrical shape such as rectangular columnar shape, character-like shape, irregular shape, and shape after the specific objects (such as flowers, animals, wood grains).

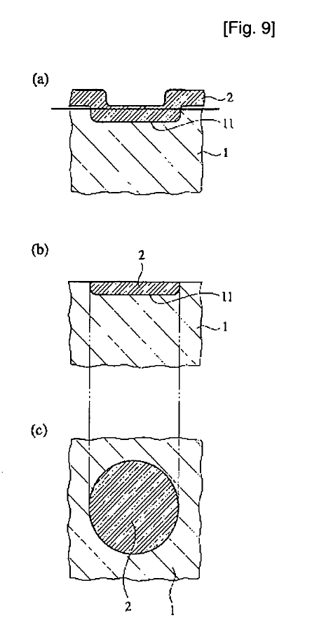

FIGS. 9, 10 and 11 illustrate the examples of installing and cutting the coloring material layer on the surface of the ceramic body where a concave area of a columnar shape is formed. In the example of FIG. 9, the coloring material layer 2 thicker than the depth of a concave portion 11 is installed. As shown in FIGS. 9(b) and (c), a round color pattern by the coloring material layer 2 filled in the concave portion 11 can be formed in an exposed surface 3, by cutting uniformly the concave portion 11 and its neighborhood to the depth reaching the ceramic body along the face of the ceramic body.

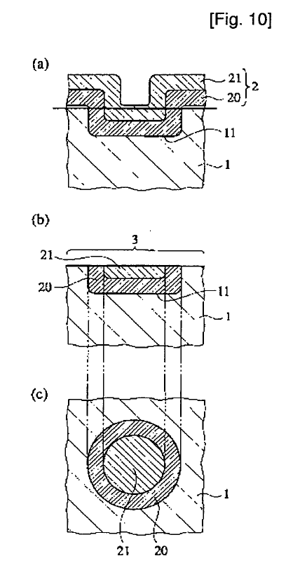

In the example of FIG. 10, the first layer 20 thinner than the depth of the concave portion 11 is laid on, and the second layer 21 is laid on it. As shown in FIGS. 10(b) and (c), the color pattern of dual circle by the coloring material layer 20 and 21 filled in the concave portion 11 can be formed in the exposed surface 3, by cutting the concave portion 11 and its neighborhood uniformly along the face of the ceramic body to the depth reaching the ceramic body.

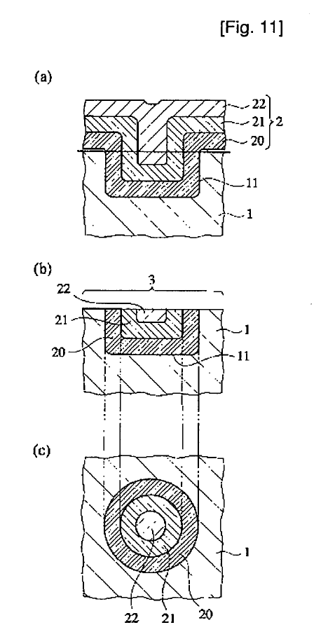

In the example of FIG. 11, the first layer 20 and the second layer 21 are laid on so that their total thicknesses are thinner than the depth of the concave 11, and the third layer 22 is laid on them. The color pattern of tripled circle composed of the coloring material layer 20, 21 and 22 filled in the concave 11 can be formed on the exposed surface 3 by cutting uniformly the concave 11 and its neighborhood to the depth reaching the ceramic body along the face of the ceramic body.

Although the ceramic having the three layers of the coloring material layer 20, 21, and 22 shown in the FIG. 11 has more than one concave 11, not necessarily all of the concave 11 and their neighborhoods are needed to be cut to the depth reaching the ceramic body, and the cutting area can be set to the depth reaching the first coloring material layer 20 or the second coloring material layer 21 and thereby can comprise various color patterns.

As described above, if the concave 11 is prepared on the ceramic body, a color pattern can be formed simply by cutting uniformly the concave 11 and its neighborhood to a given depth along the face of the ceramic body after forming the coloring material layer 2. The color patterns exposed can be modified variously by changing suitably the shape of the concave 11 or the cutting angle to the coloring material layer 2. The shapes of the concave 11 are not restricted and include, besides columnar shape, geometrical shapes such as prismatic shape, conical shape, pyramid shape, hemispherical shape and earthenware shape, and grooves imitated letter, irregular shape and specific object (e.g. flower, animal, wood grain, etc.).

In addition, various patterns can be formed on the ceramic by combining each color patterns formed on the smooth portion, on the convex portion 10, and on the concave portion 11. It is preferred that the cutting of the coloring material layer 2 is performed before the glaze firing or the second firing, but is not limited to that, and it is also acceptable that the cutting of the coloring material layer 2 is performed after the glaze firing.

### Process of Glazing and Process of Firing

After the color pattern is formed on the ceramic body as described above, the ceramic is glaze fired or secondary fired. It is preferred that the glaze firing or the secondary firing is applied at the temperature of around 1000 to 1400° C. for about 6 to 25 hours. It is preferred, but is not limited, that the glaze is coated before the glaze firing or the secondary firing. It is preferred that the glaze is coated by immersion or spraying.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

1. A decoration method of ceramic, comprising the steps of: forming at least one coloring material layer on a surface of a molded ceramic body; and cutting a portion of the coloring material layer thereby to express a color pattern on an exposed surface.

2. The method according to the claim 1 wherein the ceramic body has a smooth area on its surface, the coloring material layer is formed on the smooth area, and a cutting area of a tapered shape on the coloring material layer is formed.

3. The method according to claim 1 wherein the coloring material layer is composed of at least two layers each different in hue or luminosity.

4. The method according to claim 1, wherein the ceramic body has a convexed portion on its surface; the coloring material layer is laid on at least the convexed portion and its surrounding area, and the coloring material layer upon the convexed portion and its surrounding area is cut to the depth where the convexed portion is exposed so that the color pattern by the coloring material layer expressed on the exposed surface of the convexed portion and the surrounding area is formed.

5. The method according to claim 4, wherein the coloring material layer is composed of at least two layers of each different hue or luminosity.

6. The method according to claim 1, wherein the ceramic body has a concave portion on its surface; the coloring material layer is laid on at least the concave portion and its surrounding area, and the coloring material layer upon the concave portion and its surrounding area is cut to the depth reaching the ceramic body around the concave portion so that the color pattern by the coloring material layer expressed on the exposed surface of the concave portion and the surrounding area is formed.

7. The method according to claim 6, wherein the coloring material layer is composed of two layers or more of each different hue or luminosity.

8. The method according to claim 4, wherein the ceramic body has an additional concave portion on its surface; the coloring material layer is laid on at least the concave portion and its surrounding area, and the coloring material layer upon the concave portion and its surrounding area is cut to the depth reaching the ceramic body around the concave portion so that the color pattern by the coloring material layer expressed on the exposed surface of the concave portion and the surrounding area is formed.

9. The method according to claim 8, wherein the coloring material layer is composed of two layers or more of each different hue or luminosity.

10. The method according to claim 2 wherein the coloring material layer is composed of at least two layers each different in hue or luminosity.

11. The method according to claim 2, wherein the ceramic body has a convexed portion on its surface; the coloring material layer is laid on at least the convexed portion and its surrounding area, and the coloring material layer upon the convexed portion and its surrounding area is cut to the depth where the convexed portion is exposed so that the color pattern by the coloring material layer expressed on the exposed surface of the convexed portion and the surrounding area is formed.

12. The method according to claim 2, wherein the ceramic body has a concave portion on its surface; the coloring material layer is laid on at least the concave portion and its surrounding area, and the coloring material layer upon the concave portion and its surrounding area is cut to the depth reaching the ceramic body around the concave portion so that the color pattern by the coloring material layer expressed on the exposed surface of the concave portion and the surrounding area is formed.
